(19) United States
(12) Patent Application Publication
(10) Pub. No.: US 2005/0091514 A1
(43) Pub. Date: Apr. 28, 2005

(54) Communication device, program, and storage medium

(75) Inventors: Masaki Fukumoto, Suginami-ku (JP); Satoshi Kondo, Tokorozawa-shi (JP); Takayuki Tachihara, Shinjuku-ku (JP); Mitsuo Kikuta, Setagaya-ku (JP)

Correspondence Address: OLIFF & BERRIDGE, PLC, P.O. BOX 19928, ALEXANDRIA, VA, 22320, US

(73) Assignee: TREND MICRO INCORPORATED, Shibuya-ku (JP)

(21) Appl. No.: 10/965,749

(22) Filed: Oct. 18, 2004

(30) Foreign Application Priority Data
Oct. 23, 2003 (JP) 2003-363705

(51) Int. Cl. H04L 9/32

(52) U.S. Cl. 713/188

(57) ABSTRACT

A communication device comprises storing means, communicating means, determining means and data transfer control means. The storing means stores access parameters, the access parameters indicative of an attempt by a computer virus to install on a communication device a backdoor for transfer and installation of the virus on the communication device. The determining determines on the basis of data received by the communicating means and on the basis of the access parameters, whether a backdoor installation attempt by a computer virus is in progress. The data transfer control means controls data transfer so as to disregard and not to transfer received data when it is determined on the basis of the data and the access parameters that a backdoor installation attempt is in progress.

### TECHNICAL FIELD

The present invention relates to a device and to a method for ensuring secure communication.

### BACKGROUND ART

Computer viruses (hereinafter “viruses”) can be transmitted over networks in e-mail attachments and also in other content. Various means for detecting viruses are known, and include those which utilize, for example, a pattern matching system, such as Japanese Unexamined Patent Application Publication Nos. 2003-241987, 11-167487, and 06-337781. In a pattern matching system, code patterns unique to known viruses are extracted from virus codes and stored in a pattern file. Code in data to be inspected is compared with code patterns in the pattern file to determine whether a virus is present in the data.

Viruses attack and penetrate systems in a variety of ways. For example, a virus may exploit a Windows™ security hole and penetrate a communication device (computer) to install a malicious program. Such a security hole can exist when RPC DCOM (Remote Procedure Control Distributed Component Object Model) is implemented by one communication system (server) to execute code on another communication system (computer). If data length checking is not effectively carried out on data received at a RPC memory buffer in the computer during execution of a routine under RPC DCOM, a Trojan type virus such as “WORM_MSBLAST.A” (also known as W/32Lovsan.worm, Lovsan and W32Blaster.Worm) that targets the computer will attempt to overflow its buffer with data that contains a command to run a remote shell. Data overflowed from the buffer is stored in work areas of the computer, and when the command contained in the overflowed data is executed by the computer the remote shell becomes active. The active remote shell functions as a so-called “backdoor” for installation in the computer of a malicious program contained in an executable file “MSBLAST.EXE”.

Operation of the virus WORM_MSBLAST.A will now be described with reference to FIG. 7, which shows a communication device 100A not infected with WORM_MSBLAST.A, and a communication device 100B infected with WORM_MSBLAST.A, and which has an executable file “MSBLAST.EXE” of WORM_MSBLAST.A in its Windows™ system folder.

As shown in FIG. 7, when the program “MSBLAST.EXE” executes in communication device 100B, it detects in the network any communication device, in this case communication device 100 A, which has ports 135, 4444, and 69 open, and in which RPC is running, and then sets a destination number of a data to be transmitted to the device as “135”, and sends to the device an RPC “Bind” command (step S301). Upon receiving the “Bind” command, communication device 100A sends an RPC “Response” command to communication device 100B (step S302).

Upon receiving the “Response” command, communication device 100B sends to communication device 100A, together with an RPC “Request” command, unauthorized data having a size exceeding a storage capacity of the buffer assigned for RPC, and containing a command to run a remote shell using port 4444 (step S303). As a result, data overflow occurs in the RPC buffer in communication device 100A, and a foothold is established to run the remote shell to enable remote control by communication device 100B.

Subsequently, communication device 100B sets a destination port number for a data packet to “4444” and sends a command instructing execution of TFTP (Trivial File Transfer Protocol) to communication device 100A (step S304). Upon receiving the command, communication device 100A commences communication processing in accordance with TFTP, and sends a request to obtain “MSBLAST.EXE” to communication device 100B in response to a request from communication device 100B (step S305). In this case, the destination port number of a data packet is set to “69”.

Upon receiving the request from communication device 100A, communication device 100B transfers a copy of “MSBLAST.EXE” to communication device 100A via port 69, and the copy is stored in the Windows system folder of communication device 100A (step S306). Next, communication device 100B sets the destination port number of a data packet to be transmitted to “4444” and sends to communication device 100A a command instructing execution of “MSBLAST.EXE” (step S306); “MSBLAST.EXE” then executes in communication device 100A.

In the preceding description, explanation of only WORM_MSBLAST.A has been made. However, it is to be noted that once a virus appears, variants of the virus will appear. Thus, a number of variants of WORM_MSBLAST.A, which utilize similar access procedures from a point when a buffer is overflowed to a point where a backdoor is installed, are known.

In a conventional art employing a pattern matching system, if a variant of, for example, WORM_MSBLAST.A emerges, although the access pattern of the variant virus may be the same as the original virus, if the variant virus does not have the same code pattern as the original virus, the variant virus will not be detected. Thus, in addition to a code pattern for an original virus, it is necessary to register in a pattern file variant virus code patterns. However, registration of variant virus code patterns in a pattern file requires frequent updates of the pattern file, which is both time-consuming and inconvenient.

Moreover, it is to be noted that in a conventional pattern matching system, such as that illustrated in FIG. 7, even in a case that a pattern file stored in communication device 100A includes a registered code pattern for WORM_MSBLAST.A, the communication device will not be able to detect the virus until it receives an executable file “MSBLAST.EXE” of WORM_MSBLAST.A from communication device 100B (step S306).

### SUMMARY

The present invention has been made in view of the drawbacks of the conventional art stated above, and has as its object improved protection in communication devices against viruses.

To achieve the stated object, in accordance with one aspect of the present invention there is provided, a communication device, comprising: a storing means; a communicating means; a determining means; and a data transfer control means.

The storing means stores access parameters indicative of attempts by viruses to access a communication device to install a backdoor for transfer and installation of a virus on the communication device. The stored parameters may include a port number within a header of a data packet and the other parameters such as command and data subsequent to the command within a payload of the same data packet. The determining means determines, on the basis of data received by the communicating means and on the basis of the access parameters, whether a backdoor installation attempt by a virus is in progress. If it is determined on the basis of the data and the access parameters that a backdoor installation attempt is in progress, the data transfer control means disregards and not transfers received data.

Accordingly, the present invention is able to effectively prevent infection of a communication device with a virus.

In accordance with another aspect of the present invention, the determining means carries out determination on data to be transmitted to thereby prevent a communication device, even when infected by a virus, from spreading the virus to another communication device.

In accordance with another aspect of the present invention, a computer program is provided for causing a communication device to execute each of these storing, determining, and controlling processes. There is also provided a computer-readable medium for storing the computer program.

Accordingly, the present invention provides improved protection for communication devices against viruses.

### BRIEF DESCRIPTION OF THE DRAWINGS

FIG. 1 is a block diagram illustrating a hardware configuration of a computer apparatus according to an embodiment of the present invention;

FIG. 2 is a table illustrating a data structure of a pattern file in the embodiment;

FIG. 3 is a diagram illustrating a configuration of software modules in the computer apparatus according to the embodiment;

FIG. 4 is a flow chart showing processing performed by a Firewall during reception of a data packet, according to the embodiment;

FIG. 5 is a flow chart showing processing performed by the Firewall during transmission of a data packet, according to the embodiment;

FIG. 6 illustrates a case in which data that is separately contained in two data packets with consecutive sequence numbers matches data registered in the pattern file, according to a modification of the present invention; and

FIG. 7 is a sequence chart showing an operation of WORM_MSBLAST.A, according to the related art.

### DESCRIPTION OF PREFERRED EMBODIMENTS

An embodiment of the present invention will now be described in detail below with reference to the accompanying drawings.

Configuration of Embodiment

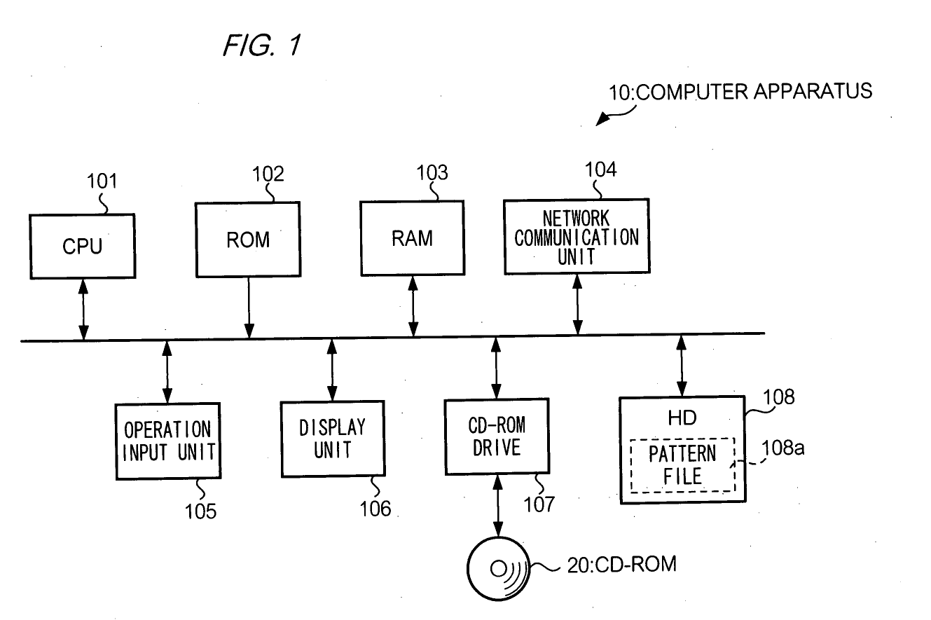

FIG. 1 is a block diagram illustrating a hardware configuration of a computer apparatus 10 according to the present invention. Computer apparatus 10 has network communication capability and can be used, for example, as a network terminal, content server, gateway server, or proxy server.

Referring to FIG. 1, a CPU (central processing unit) 101 controls individual units of computer apparatus 10 by executing various programs stored in a ROM (read only memory) 102 and a HD (hard disk) 108. ROM 102 may store, for example, a program for performing basic control of each unit of computer apparatus 10. A RAM (random access memory) 103 is used as a work area of CPU 101. A network communication unit 104 controls communication with another networked computer apparatus through a LAN (local area network), the Internet, and so on. An operation input unit 105 may include a keyboard and a mouse. A display unit 106 may be a LCD (liquid crystal display) or a CRT (cathode ray tube) display. A CD-ROM drive 107 reads a program and data stored on a CD-ROM 20; and on which firewall application software is also recorded.

The firewall application software provides computer apparatus 10 with various functions; for example, a function for detecting penetration attempt by a virus, such as WORM_MSBLAST.A or CODERED.A (also known as CODE RED, CODERED.WORM, HBC, and W32/Bady.worm), at a stage prior to reception of an executable file of the virus; a function for checking whether computer apparatus 10 is infected with a virus; a function for deleting an executable file of a virus when infection is detected; and a function for restoring registry information overwritten by a virus.

As an OS (operating system) used in computer apparatus 10, for example, Windows XP™ may be installed on HD 108. Needless to say, another Windows OS, such as Windows NT™, Windows 2000™, Windows Server 2003™, or the like may be installed instead of Windows XP™. Further, on HD 108, applications for controlling communication, for example, RPC (Remote Procedure Call) communication, IIS (Internet Information Server) communication, and TFTP (Trivial File Transfer Protocol) communication (hereafter referred to as “communication applications”) are installed. Also, in using application software for performing data communication with another computer apparatus by utilizing such communication applications, firewall application software and the like read from CD-ROM 20 are installed on HD108.

In addition, a pattern file 108a is stored on HD 108, so that access to a sever or the like of a provider of the firewall application software enables pattern file 108a to be updated so as to provide protection against new viruses.

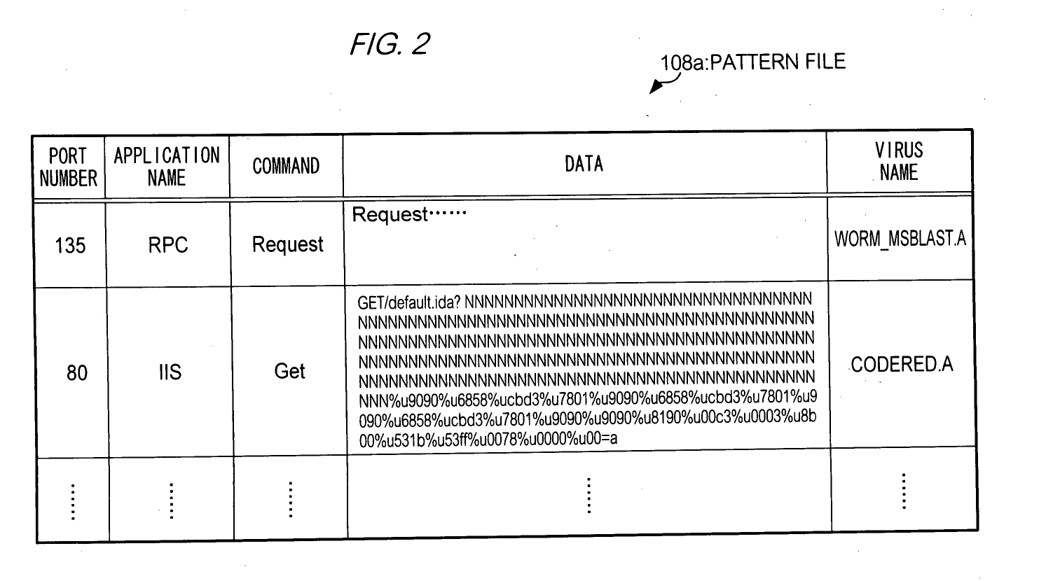

FIG. 2 is a table illustrating a data structure of pattern file 108a. As shown, in pattern file 108a, sets of access parameters of viruses, such as WORM.MSBLAST.A and CODERED.A, are registered. Each set of access parameters includes a port number, a name of a communication application corresponding to the port number, data (a command and data subsequent to the command), and a virus name. A set of access parameters registered for a virus is indicative of access characteristics of the virus when it attempts to install a backdoor on computer apparatus 10 to replicate itself on the apparatus, by taking advantage of OS or communication application security holes. Specifically, a port number is used by a virus when it accesses computer apparatus 10 over a network. The data is input to a buffer assigned for a communication application and is used to install a backdoor on computer apparatus 10 by overflowing the buffer.

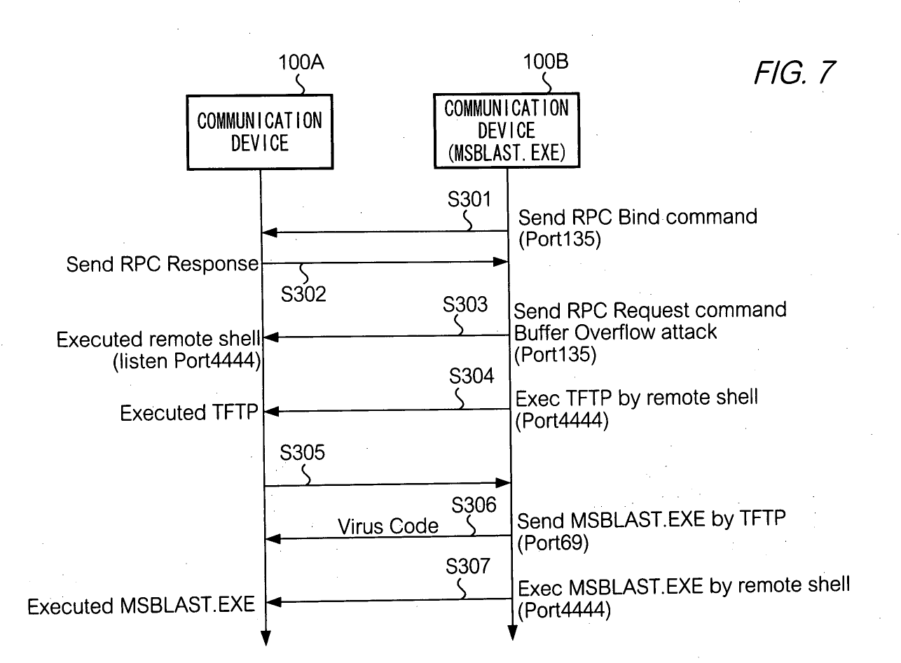

For example, as shown in FIG. 7, WORM_MSBLAST.A uses a “Request” command to install a backdoor by overflowing a buffer for RPC. Thus, as shown in FIG. 2, in pattern file 108a, port number “135” corresponding to RPC, application name “RPC”, command “Request”, data that is input together with the command, and virus name “WORM_MSBLAST.A” are registered. In FIG. 2, with regard to WORM_MSBLAST.A, data that is input to the buffer is not specified. In communication employing IIS, CODERED.A uses a “Get” command to install a backdoor by overflowing a buffer for IIS. Thus, as shown in FIG. 2, in pattern file 108a, port number “80” corresponding to IIS, application name “IIS”, command “Get”, data that is input to the buffer together with the command, and virus name “CODERED.A” are registered.

In FIG. 2, each “data” field may include, instead of an entire data set including such a command, only data part of a data set that includes such a command, and/or information indicative of characteristics of data including the command. For example, each “data” field may include code for a first 20 characters including a command, and code for the last 20 characters.

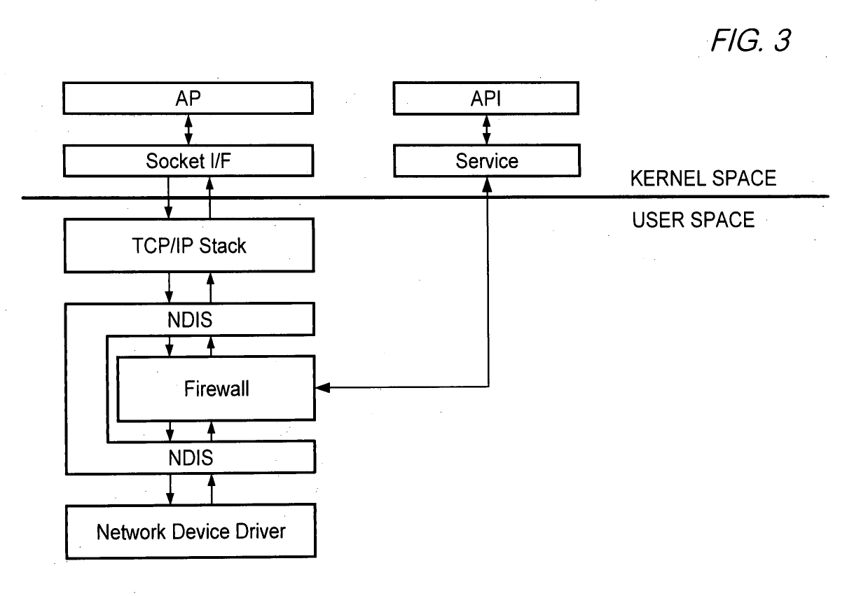

FIG. 3 is a diagram illustrating a configuration of software modules in computer apparatus 10. Referring to FIG. 3, a Firewall has a function for preventing penetration of viruses, such as WORM_MSBLAST.A and CODERED.A, in addition to a SPI (Stateful Packet Inspection) function and an IDS (Intrusion Detection System) function. For example, during processing by the Firewall, CPU 101 obtains a destination port number from a header and also obtains data from the payload of the data packet received through network communication unit 104 (including a network device driver), and subjected to NDIS (Network Driver Interface Specification) based processing.

By comparing the obtained destination port number and access parameters registered in pattern file 108a, CPU 101 determines whether the packet access constitutes an unauthorized access involving an attempt by a virus to install on computer apparatus 10 a backdoor by which to transfer a copy of itself. In a case that CPU 101 determines that the access is unauthorized, it discards the data packet and breaks the connection via which the data packet was received. On the other hand, in a case that CPU 101 determines that the access is authorized, it processes the data packet according to the NDIS, TCP/IP Stack, and Socket I/F and then transfers it to AP (application software).

Conversely, for transmission of data from computer apparatus 10, during processing by a Firewall, CPU 101 obtains a destination port number and data from a data packet that has been processed by AP, Socket I/F, TCP/IP Stack, and NDIS. Subsequently, by comparing the obtained destination port number and data with access parameters registered in pattern file 108a, CPU 101 determines whether the packet access constitutes an unauthorized access involving an attempt by a virus to install on a target computer apparatus a backdoor by which to transfer a copy of itself. In a case that CPU 101 determines that the access is unauthorized, it discards the data packet and breaks the connection via which the data packet was to be transmitted. On the other hand, in a case that CPU 101 determines that the access is not unauthorized, it transmits the data packet from the network communication unit 104 to the target computer apparatus through processing by the NDIS.

An API (application programming interface) and Service include the following functions: updating pattern file 108a; reporting to a user details of unauthorized access detected by the Firewall; obtaining information (and the like) indicating a type of OS and notifying the Firewall; and notifying the user of start and stopping of the Firewall.

Operation of Embodiment

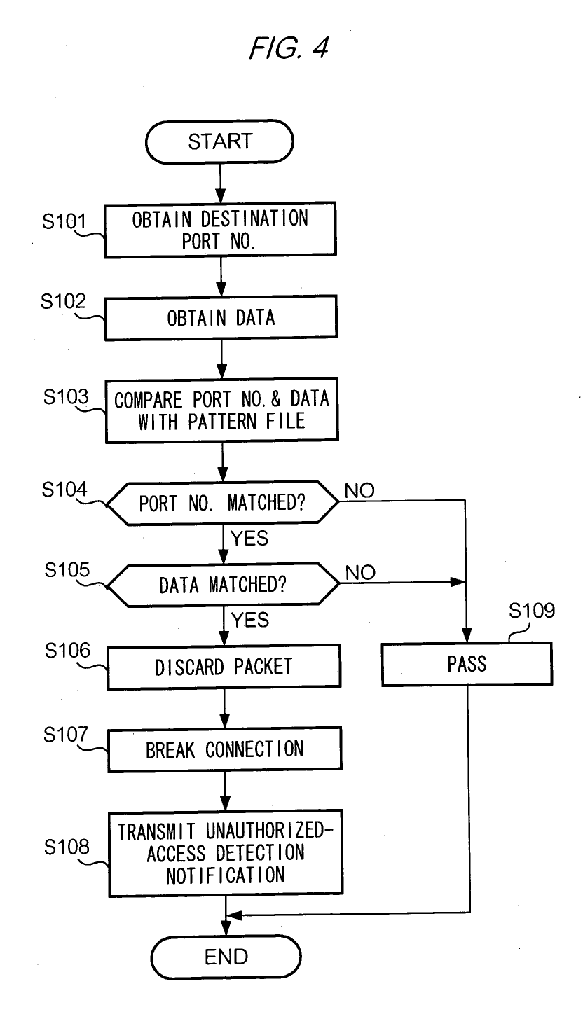

FIG. 4 is a flow chart showing processing performed by Firewall during reception of a data packet. Computer apparatus 10 starts a communication application, such as RPC or IIS, as required, when application software is running, so as to start data communication with a target computer apparatus over a network. After receiving a data packet and processing the data packet according to the NDIS, computer apparatus 10 commences the processes performed by the Firewall, as shown in FIG. 4.

When computer apparatus 10 starts communication utilizing a communication application, the OS running on the apparatus assigns a buffer having a predetermined storage capacity to the communication application. This buffer is provided in RAM 103 or HD 108 and, in communication utilizing a communication application, serves as a memory area for temporarily storing data received from the target computer apparatus to process the data in accordance with the communication application.

First, CPU 101 obtains a destination port number from the header of the received data packet (step S101). CPU 101 also obtains data from the payload of the data packet (step S102). Next, CPU 101 compares the obtained destination port number and data with access parameters (a port number and data) for each virus registered in pattern file 108a. In the comparison with pattern file 108a, CPU 101 first determines whether the port numbers match each other. In a case that they are determined to match each other, CPU 101 then determines whether commands match each other. In a case that the commands match each other, CPU 101 determines whether both sets of data subsequent to the commands match each other. In this manner, such step-by-step comparison with pattern file 108a allows for efficient checking for each data packet.

In a case that the destination port number and data obtained from the data packet concurs with parameters of a virus registered in pattern file 108a (“YES” in both steps S104 and S105), CPU 101 determines that the packet access constitutes an unauthorized access involving an attempt by a virus to install on computer apparatus 10 a backdoor by which to transfer a copy of itself. In this case, CPU 101 discards the received data packet (step S106) and breaks the connection via which the data packet was received (step S107).

For example, in a case that the destination port number of a received data packet is “80” and data of the data packet is the same as the data for CODERED.A registered in pattern file 108a shown in FIG. 2, CPU 101 determines that the packet access constitutes an unauthorized access involving an attempt by CODERED.A attempting to install on computer apparatus 10 a backdoor to transfer a copy of itself to computer apparatus 10. CPU 101 then discards the received data packet and breaks the associated connection.

Thereafter, CPU 101 sends to the API an unauthorized-access detection notification indicating that unauthorized access has been detected (step S108), and terminates the processing shown in FIG. 4. Upon receiving the unauthorized-access detection notification, the API causes display unit 106 to display messages indicating the attempted virus penetration into computer apparatus 10, the name of the virus, the suspension of communication due to the unauthorized access, and so on. Naturally, these messages may be reported to the user as voice messages.

On the other hand, in a case that the destination port number and data obtained from the data packet do not concur with access parameters registered in pattern file 108a (“NO” in at least one of steps S104 and S105), CPU 101 permits the passage of the data packet (step S109) and terminates the processes shown in FIG. 4. The data packet permitted to pass in S109 is processed by the NDIS, TCP/IP Stack, and Socket I/F, transferred to AP (application software) as received data, and is input to a buffer assigned for a communication application.

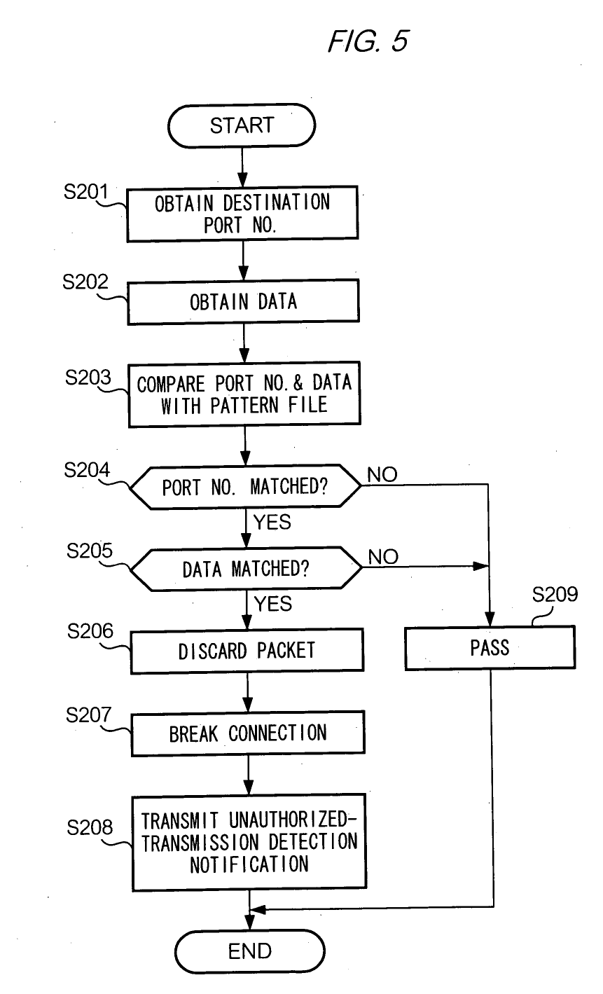

Processing by the Firewall during transmission of a data packet will now be described with reference to a flow chart shown in FIG. 5. Computer apparatus 10 starts communication applications, such as RPC are IIS, as required when application software is running, to start data communication with a target computer apparatus. When transmitting data to the target computer apparatus, computer apparatus 10 commences the processes performed by Firewall as shown in FIG. 5, after the completion of data processing by the AP, Socket I/F, TCI/IP Stack, and NDIS.

To transmit data, the AP performs processing for specifying data to be transmitted, a destination port number, a communication address, and the like; and the Socket I/F performs processing for generating a data packet in accordance with the specified information.

First, CPU 101 obtains a destination port number from the header of a data packet to be transmitted (step S201). CPU 101 also obtains data from the payload of the data packet (step S202). Next, CPU 101 compares the obtained destination port number and data with access parameters (a port number and data) for each virus registered in pattern file 108a (step S203).

As a result, in a case that the destination port number and data obtained from the data packet match one set of access parameters of a virus registered in pattern file 108a (“YES” in both steps S204 and S205), CPU 101 determines that the packet access constitutes an unauthorized access involving an attempt by the virus to install on the target computer apparatus a backdoor by which to transfer a copy of the virus. In this case, CPU 101 discards the data packet (step S206). CPU 101 breaks the connection via which the data packet was to be transmitted (step S207), to thereby suspend transmission of the data packet. An attempt to transfer such a data packet indicates that the computer apparatus 10 is infected with a virus, such as WORM.MSBLAST.A or CODERED.A.

Thereafter, CPU 101 sends to the API an unauthorized-transmission detection notification indicating that unauthorized transmission was attempted (step S208), and then terminates the processes shown in FIG. 5. Upon receiving the unauthorized-transmission detection notification, the API causes display unit 106 to display messages indicating the virus infection of computer apparatus 10, the name of the virus, and the suspension of communication due to the authorized transmission attempt, and the like. The CPU 101 also starts a vaccination program installed on HD 108 to delete the executable file of the virus and to restore registry information maliciously overwritten by the virus.

For example, in a case that the target port number of a data packet to be transmitted is “80” and the data of the data packet is the same as the data for CODERED.A registered in pattern file 108a shown in FIG. 2, CPU 101 determines that the packet access constitutes an unauthorized access involving an attempt by CODERED.A to install on the target computer apparatus a backdoor to transfer a copy of itself, thus suspending the transmission of the data packet. In addition, CPU 101 starts a vaccination program for CODERED.A to delete the executable file of CODERED.A and to restore registry information.

When processing according to a vaccination program is executed, a vaccination file that includes data needed for detecting the executable files of viruses and restoring registry information is referred to. The vaccination program and vaccination file can also be updated to deal with the latest viruses, as with the pattern file 108a.

On the other hand, in a case that the destination port number and data obtained from the data packet do not match any set of access parameters registered in pattern file 108a (“NO” in at least one of steps S204 and S205), CPU 101 permits the passage of the data packet (step S209) and terminates the processes shown in FIG. 5. The data packet permitted to pass in step S209 is processed by the NDIS and is then transmitted from network communication unit 104 to the target computer apparatus.

As described above, since computer apparatus 10 detects access caused by a virus attempting to install a backdoor on computer apparatus 10 and breaks the associated connection, the embodiment makes it possible to detect and block the penetration of viruses, such as WORM_MSBLAST.A and CODERED.A, at a stage prior to the reception of the executable file of the virus. Computer apparatus 10 can also detect a variant virus if access characteristics for installing a backdoor matches a set of access parameters registered in pattern file 108a.

Further, since computer apparatus 10 also checks data packets to be transmitted by using pattern file 108a, another computer apparatus can be prevented from being infected with a virus, even if computer apparatus 10 is infected with a virus. Computer apparatus 10 can also determine whether it is infected with a virus by monitoring data packets to be transmitted.

Modifications

While the embodiment of the present invention has been described above, the present invention can be practiced with other various forms without departing from the sprit and scope of the present invention. The above-described embodiment is thus merely an example of one aspect of the present invention, and the modifications described below are also possible.

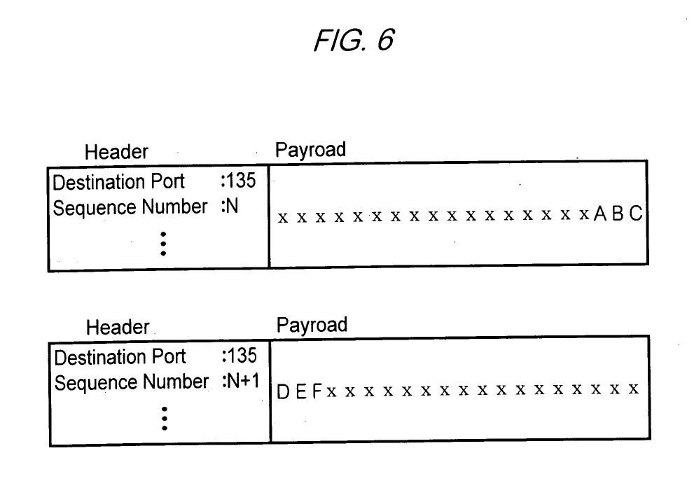

The illustrated embodiment has been described with regard to a case in which, for each data packet, a comparison is performed with pattern file 108a. As shown in FIG. 6, however, if payload data “ABC DEF” is contained in separate data packets with sequence number “N” and sequence number “N+1” while an access parameter “ABC DEF” is registered in pattern file 108a, the configuration of the above-described embodiment cannot determine that access using such a data structure is unauthorized.

Accordingly, in the processing shown in FIGS. 4 and 5, CPU 101 may combine data included in two or more data packets with consecutive sequence numbers to compare the data with parameters in pattern file 108a. Needless to say, a number of data packets combined at any one time can be arbitrarily set. In a case that it is determined that the combined data and a corresponding destination port number match one set of access parameters (a port number and data) registered in pattern file 108a, CPU 10 discards one or more of the data packets whose data was combined, and breaks a connection via which the data packets were received or a connection via which the data packets were to be transmitted. On the other hand, in a case that the combined data and a corresponding destination port number do not match any set of access parameters registered in pattern file 108a, CPU 101 permits the passage of the data packets whose data was combined.

However, when data included in a plurality of data packets are combined to perform a comparison with pattern file 108a, as described above, processing efficiency is reduced as a result of the data combination (and the like). Accordingly, comparison with pattern file 108a may preferably be performed as explained below, so as to prevent a reduction in processing efficiency. In the following explanation, however, description of matching of destination port numbers will be omitted.

When corn paring data obtained from a data packet with data registered in pattern file 108a, CPU 101 determines whether the end portion of data included in the data packet matches a part of a plurality of codes beginning from the head portion of data registered in pattern file 108a. As a result, in a case that a partial match is detected, CPU 101 stores the matched plurality of codes in RAM 103. In this case, CPU 101 designates the sequence number of the data packet having the matched codes as “N”.

Next, CPU 101 compares data obtained from a data packet with sequence number “N+1” with data registered in pattern file 108a. In this case, of the data registered in pattern file 108a, CPU 101 determines whether or not a remaining portion except the plurality of codes stored in RAM 103 matches the head portion of the data obtained from the data packet with sequence number “N+1”. As a result, in a case that it is determined that the remaining portion also matches, CPU 101 determines that the data that is contained in the data packets with sequence number “N” and sequence number “N+1” matches an entire data sequence registered in pattern file 108a. With this arrangement, data that is contained in two separate data packets with two consecutive sequence numbers can also be compared with pattern file 108a without a reduction in processing efficiency.

In the above-described embodiment, it is sufficient for the processing shown in FIG. 4 to be performed before received data is input to a buffer for a communication application, i.e., before received data is transferred to a communications application. Thus, in the case where data is contained in two separate data packets having consecutive sequence numbers, the processing shown in FIG. 4 may be performed, for example, after data of individual data packets is combined by the Socket I/F and before the combined data is input to the buffer for the communication application. Since it is also sufficient for the processing shown in FIG. 5 to be performed before packet transmission, the processing may be performed, for example, at a stage before a data packet is generated by the Socket I/F. In addition, in the above-described embodiment, computer 10 executes the processing shown in FIGS. 4 and 5 in accordance with a program read from CD-ROM 20. Such a program for executing the processing according to the present invention may be supplied to computer apparatus 10 by communication through a telecommunications line. Also, the present invention is not limited to packet communications and connection-oriented communications. Further, the present invention may also be applied to, for example, wireless terminals linked in a public wireless LAN and mobile apparatuses/devices, such as portable telephones and mobile computers. The storage medium may be a DVD (digital versatile disc), diskette, memory card, or the like.

1. A communication device, comprising:
storing means for storing access parameters, said access parameters indicative of an attempt by a computer virus to install on a communication device a backdoor for transfer and installation of the computer virus on said communication device;
communicating means;
determining means for determining, on the basis of data received by said communicating means and on the basis of said access parameters, whether a backdoor installation attempt by a computer virus is in progress; and
data transfer control means for controlling transfer of received data, said control means disregarding and not transferring received data when it is determined on the basis of the data and said access parameters that a backdoor installation attempt is in progress.

2. A communication device according to claim 1, wherein:
said data transfer control means further breaks a connection when it is determined on the basis of data received via the connection and said access parameters that a backdoor installation attempt is in progress.

3. A communication device according to claim 1, wherein:
said determining means determines whether a backdoor installation attempt by a computer virus is in progress on the basis of data received by the communicating means and on the basis of said access parameters, said data being contained in two separate packets having consecutive sequence numbers; and
said data transfer control means disregards and does not transfer at least one of the two packets, when said determining means determines that a backdoor installation attempt is in progress.

4. A communication device according to claim 1, further comprising reporting means for reporting, when said determining means determines that a backdoor installation attempt is in progress, an attempt by a computer virus to penetrate the communication device.

5. A communication device, comprising:
storing means for storing access parameters indicative of an attempt by a computer virus to install on a communication device a backdoor for transfer and installation of the computer virus on said communication device;
communicating means;
determining means for determining, on the basis of data to be transmitted by said communicating means and on the basis of said access parameters, whether a backdoor installation attempt to another communication device by a computer virus is in progress; and
data transfer control means for controlling transfer of data to be transmitted, said control means disregarding and not transferring data to be transmitted when it is determined on the basis of the data and said access parameters that a backdoor installation attempt to another communication device is in progress.

6. A communication device according to claim 5, wherein:
said data transfer control means further breaks a connection when it is determined on the basis of data to be transmitted via the connection and said access parameters that a backdoor installation attempt to another communication device is in progress.

7. The communication device according to claim 5, wherein:
said determining means determines whether a backdoor installation attempt by a computer virus to another communication device is in progress on the basis of data to be transmitted by the communicating means and on the basis of said access parameters, said data being contained in two separate packets having consecutive sequence numbers; and
said data transfer control means disregards and does not transfer at least one of the two packets, when said determining means determines that a backdoor installation attempt to another communication device is in progress.

8. A communication device according to claim 5, further comprising reporting means for reporting, when said determining means determines that a backdoor installation attempt to another communicating device is in progress, that said communication device is infected with a computer virus.

9. A communication device of claim 5, further comprising restoring means for removing, when said determining means determines that a backdoor installation attempt to another communicating device is in progress, the computer virus from said communication device and restoring control information of the communication device overwritten by the computer virus.

10. A program product for causing a communication device to:
store access parameters in a memory, said access parameters indicative of an attempt by a computer virus to install on a communication device a backdoor for transfer and installation of the computer virus on said communication device;
determine whether a backdoor installation attempt by a computer virus is in progress, on the basis of data received by a communicating means and on the basis of said access parameters; and
control data transfer so as to disregard and not transfer received data when it is determined on the basis of the data and said access parameters that a backdoor installation attempt is in progress.

11. A program product for causing a communication device to:
store access parameters in a memory, said access parameters indicative of an attempt by a computer virus to install on a communication device a backdoor for transfer and installation of the computer virus on said communication device;
determine whether a backdoor installation attempt by a computer virus to another communication device is in progress, on the basis of data to be transmitted by a communicating means and on the basis of said access parameters; and
control data transfer so as to disregard and not transfer data to be transmitted, when it is determined on the basis of the data and said access parameters that a backdoor installation attempt to another communication device is in progress.

12. A computer-readable storage medium on which a program is recorded for causing a communication device to:
store access parameters in a memory, said access parameters indicative of an attempt by a computer virus to install on a communication device a backdoor for transfer and installation of the computer virus on said communication device;
determine whether a backdoor installation attempt by a computer virus is in progress, on the basis of data received by a communicating means and on the basis of said set pf access parameters; and
control data transfer so as to disregard and not transfer received data when it is determined on the basis of the data and said access parameters that a backdoor installation attempt is in progress.

13. A computer-readable storage medium on which a program is recorded for causing a communication device to:
store access parameters in a memory, said access parameters indicative of an attempt by a computer virus to install on a communication device a backdoor for transfer and installation of the computer virus on said communication device;
determine whether a backdoor installation attempt to another communication device by a computer virus is in progress, on the basis of data to be transmitted by a communicating means and on the basis of said access parameters; and
control data transfer so as to disregard and not transfer data to be transmitted, when it is determined on the basis of the data and said access parameters that a backdoor installation attempt to another communication device is in progress.
